(19) United States
(12) Patent Application Publication
(10) Pub. No.: US 2023/0155158 A1
(43) Pub. Date: May 18, 2023

(54) FUEL-CELL BATTERY PACK

(71) Applicant: GREENGT SA, Lausanne (CH)

(72) Inventor: Eric MOUREAU, Evian les Bains (FR)

(21) Appl. No.: 17/985,799

(22) Filed: Nov. 11, 2022

(30) Foreign Application Priority Data
Nov. 12, 2021 (WO) 21207928.9

(51) Int. Cl. H01M 8/249; H01M 8/2404; H01M 8/2457; H01M 8/248

(52) U.S. Cl. CPC H01M 8/249; H01M 8/2404; H01M 8/2457; H01M 8/248; H01M 2250/20

(57) ABSTRACT

The fuel-cell battery pack for an electric propulsion vehicle includes at least one fuel-cell stack and a casing containing the fuel-cell stack. The casing includes at least one opening providing access to a housing. The fuel-cell stack is inserted into the opening by one of its ends such that one of the two end plates of the fuel-cell stack is located within the housing whilst the other end of the fuel-cell stack protrudes out of the opening. The end plate which is located outside of the casing has a peripheral rim provided to be kept in abutment against the periphery of the opening. Finally, the inlets and outlets for the reactive anode gas, the reactive cathode gas and the cooling fluid are arranged on the end plate which is located outside of the casing.

### CROSS-REFERENCE TO RELATED APPLICATIONS

This application claims priority to EP 21207928.9 filed Nov. 12, 2021, the entire contents of which are hereby incorporated by reference.

### BACKGROUND OF THE INVENTION

### Field of the Invention

The present invention relates to a fuel-cell battery pack intended to supply power to an electric propulsion vehicle, and intended more particularly to supply power to an electric propulsion automobile, in particular an electric propulsion racing car. It should be noted that the term “vehicle” herein means in general any transport means able to have an electric motor (for example: car, commercial automobile, motorcycle, helicopter, aeroplane, drone, boat . . . ). The fuel-cell battery pack comprises:
at least one fuel-cell stack comprising two end plates, a stack of fuel cells which is compressed between the two end plates, and a linking structure fixedly anchored to the two end plates and pre-stressed so as to pull the end plates together in order to compress the stack of fuel cells, and further comprising inlets and outlets for a reactive anode gas, a reactive cathode gas and a cooling fluid;
a casing comprising a housing therein for said at least one fuel-cell stack, and comprising an opening providing access to said housing.

### Description of the Related Art

A fuel-cell stack consists of a stack of electrochemical fuel cells which are electrically connected in series. When they are supplied with a flow of fuel and with a flow of oxidant, the electrochemical cells of a fuel-cell stack are the sites of a controlled electrochemical reaction which produces electrical energy, as well as reaction products and heat.

The electrochemical cells of fuel-cell stacks designed for applications in the field of automobile propulsion are generally of the type comprising a polymer electrolyte membrane (PEM) arranged between two porous electrodes (a cathode and an anode). The PEM is sandwiched between the anode and the cathode and the set of these three elements form what is called a membrane electrode assembly (MEA). In order to promote the desired electrochemical reaction, the anode and the cathode of the MEA generally each comprise a first layer arranged in the immediate proximity of the membrane, which layer comprises one or more catalysts, as well as other materials such as carbon particles. Each of the electrodes of the MEA further comprises a gas diffusion layer (GDL) arranged on at least one of the outer faces of the MEA. The GDLs are not only gas-permeable but also electrically conductive. Each GDL thus connects the first layer of one of the porous electrodes to the corresponding face of the MEA. The pores of the GDLs are usually large whilst the pores in the first layers are very small. This is the reason why it is likewise known to insert a porous, conductive barrier layer (MPL) between the first layer and the GDL, so as to form an intermediate phase between the large pores of the GDL and the much smaller pores of the first layer. Such an MEA is called a seven-layer MEA (as opposed to five layers in the case where there is no porous barrier layer).

A PEM electrochemical cell functions in the following manner A flow of hydrogen (the fuel) is provided to the cell through the porous anode. When reaching the first layer of the anode, the hydrogen is oxidised by the catalyst(s) which is/are present, causing the appearance of cations (protons) and electrons. The protons can migrate through the electrolyte membrane towards the cathode. Simultaneously, a flow of a gas containing oxygen (the oxidant) is provided on the side of the cathode. The oxygen moves through the porous cathode and reacts with the protons which have passed through the electrolyte membrane. The electrons, for their part, pass from the anode to the cathode by making use of an external conductor, which produces an electric current. The electrochemical reaction between the hydrogen and the oxygen also generates heat. This heat tends to increase the temperature of the fuel-cell stack.

In order to obtain a large amount of electrical energy, it is known to stack a certain number of electrochemical cells. In this case, a separating wall produced from an electrically conductive material is inserted between each cell such that the cells are connected in series. Such a stack of electrochemical cells is called a fuel-cell stack, and the separating walls between the cells are called bipolar separators. The electrochemical cells and the bipolar separators are further compressed between two end plates in order to ensure, on the one hand, the sealing tightness of the different circuits in which the reactive gases and cooling fluid flow, and to ensure, on the other hand, good electrical contact between the stacked elements. To this end, the fuel-cell stack usually comprises a linking structure arranged to push the two end plates towards each other. In a conventional manner, the linking structure can comprise a plurality of tie rods having threaded ends which are bolted onto the two end plates so as to generate the necessary clamping force between the plates. Other types of linking structure are also known. By way of example, a linking structure can be formed by a compression housing in which the stack of fuel cells is accommodated.

A conventional fuel-cell stack is thus essentially formed of a stack within which MEAs and bipolar separators alternate. Thus, normally there is always a bipolar separator inserted between two membrane electrode assemblies and, reciprocally, a membrane electrode assembly is normally always sandwiched between two bipolar separators. In addition to acting as a sealing wall between two neighbouring fuel cells, the bipolar separators are generally designed to allow the fuel-cell stack to be supplied with reactants and cooled. To this end, each bipolar separator generally comprises three types of conduit: conduits used for the passage of the fuel gas supplied to the anode, conduits used for the passage of the gaseous oxidant supplied to the cathode and, finally, conduits used for the passage of the cooling liquid.

Furthermore, whatever the mode of propulsion used, the chassis of a vehicle must have sufficient rigidity to resist accelerations and thus forces of inertia. Moreover, the chassis must also resist the forces exerted by the surrounding environment (unevenness of the terrain in the case of wheeled vehicles, turbulence in the case of aircraft, waves in the case of boats) which are combined with the forces associated with acceleration. At the same time, the weight of a vehicle should preferably be minimised. One way of meeting these two contradictory requirements is to assemble the different components of the vehicle directly together such that the components themselves ensure (or at the very least contribute to ensuring) the rigidity of the structure. Obviously, the ideal solution, as far as weight is concerned, would be to dispense with a chassis entirely and ensure that the different assembled elements form a self-supporting structure having sufficient rigidity. In the particular case of an electric propulsion racing car which is powered by one or more fuel-cell stacks, the different components able to be assembled directly together so that they themselves contribute to the rigidity of the structure are mainly the vehicle front end, the cockpit, the fuel-cell battery pack and the vehicle back end. Since electric motors are normally smaller and lighter than petrol engines, they can, for example, be integrated into the vehicle back end as described in patent document EP2210757A1. Whatever the type of vehicle, there is a need for a fuel-cell battery pack which is very light and also sufficiently resistant to mechanical stresses to be integrated in a self-supporting structure.

Furthermore, still using the example of racing cars, it is important to note that these must have a whole range of features which wouldn't even be thought of for private cars, and this regardless of their mode of propulsion. Among the features unique to circuit racing, there is in particular the pit stop. This must run smoothly. Indeed, it is easy to understand that, during the race, a tyre change or a repair must be effected as quickly as possible otherwise the driver will lose all his chances of winning. Therefore, in motor sport, success is not determined solely on the track. In the case of an electric propulsion racing car which is powered by one or more fuel-cell stacks, these fuel-cell stacks must in particular be able to be changed as needed at a speed at least equal to that which is achieved nowadays in changing the wheels of a vehicle. A need to provide a fuel-cell battery pack which allows the replacement of a fuel-cell stack in a simple and rapid manner is thus apparent.

Another problem is that polymer electrolyte membrane fuel-cell stacks are structures which have, intrinsic to their design, a certain flexibility, but the performance of which risks being compromised if the stacks are even slightly deformed by bending or twisting. For optimum functioning of the fuel-cell battery pack of a vehicle, it would be desirable for the casing of the fuel-cell battery pack to be arranged so as to provide effective seating of the fuel-cell stack(-s) without thereby complicating the placement and removal thereof.

### SUMMARY OF THE INVENTION

One aim of the present invention is to overcome the disadvantages of the prior art which have just been explained. The present invention achieves this aim as well as others by providing a fuel-cell battery pack for an electric propulsion vehicle as disclosed and claimed.

In accordance with the invention, said at least one fuel-cell stack is inserted in the opening by one of its ends such that one of the end plates (referred to as the small end plate) is located within the housing, whilst the other end of the fuel-cell stack protrudes out of the opening, the other end plate (referred to as the large end plate) being located outside of the casing. The inlets and outlets for the reactive anode gas, the reactive cathode gas and the cooling fluid are arranged on the large end plate, and this plate has a peripheral rim provided to be kept in abutment against the periphery of the opening.

It will be understood from the preceding statements that the inlets and outlets for the reactive anode gas, the reactive cathode gas and the cooling fluid are all accessible from outside of the casing, such that the fuel-cell stack can be introduced into the housing, or removed therefrom, in a simple manner Moreover, since the large end plate is arranged so as to cover the opening when the fuel-cell stack is in place in the housing, it is not necessary to provide a panel or cover to close the opening. Finally, the connections for the conduits supplying the fuel-cell stack with reactive gas and cooling fluid are accessible from outside of the casing.

In accordance with a first advantageous embodiment, the peripheral rim of the large end plate is provided to be fixed to the casing at at least two points when the fuel-cell stack is in place. It will be understood that, once fixed, the large end plate contributes to the rigidity of the fuel-cell battery pack.

In accordance with a second advantageous embodiment, the casing comprises a guide arranged in the housing so as to cooperate with the small end plate to guide it when the fuel-cell stack is being placed in the housing, as well as to keep the small end plate in its position when the fuel-cell stack is in place. It will be understood that the presence of a guide reduces the risk that the fuel-cell stack will be deformed by the forces of inertia generated when the vehicle is moving, or by imprecise handling during placement or removal of the fuel-cell stack.

In accordance with a preferred variant of the second embodiment, the guide comprises, on the one hand, at least one cavity provided in a wall arranged at the base of the housing opposite the opening and, on the other hand, at least one pin mounted on the small end plate of the fuel-cell stack and oriented in the stacking direction of the fuel cells, the pin being arranged to come to be inserted into the cavity and to be guided thereby when the fuel-cell stack is placed in the casing.

### BRIEF DESCRIPTION OF THE DRAWINGS

Other features and advantages of the present invention will become clear upon reading the following description, given solely by way of non-limiting example, and made with reference to the attached drawings in which:

FIG. 1 is a three-quarter perspective view showing the front side and the left lateral side of a fuel-cell battery pack which is in accordance with a particular embodiment of the invention;

FIG. 2 is a three-quarter perspective view showing the rear side and the right lateral side of the fuel-cell battery pack of FIG. 1;

FIG. 3 is a side view showing the right lateral side of the fuel-cell battery pack of FIGS. 1 and 2;

FIG. 4 is a cross-sectional view at B-B of FIG. 3;

FIG. 5 is a double-view drawing reproducing the side view of FIG. 3 alongside a cross-sectional view at A-A of the side view;

FIG. 6 is a three-quarter perspective view of one of the fuel-cell stacks of the fuel-cell battery pack of FIGS. 1 to 5;

FIG. 7 is a partial enlarged view of a part of the cross-sectional view of FIG. 5 showing more particularly female electrical connectors of two fuel-cell stacks, as well as a bridging bar arranged to connect the two female electrical connectors through the wall separating the housings of the two fuel-cell stacks;

FIG. 8 is a partial enlarged view of a part of the cross-sectional view of FIG. 5 showing the mounting of one of the female electrical connectors in the end plate of a fuel-cell stack.

### DESCRIPTION OF THE PREFERRED EMBODIMENTS

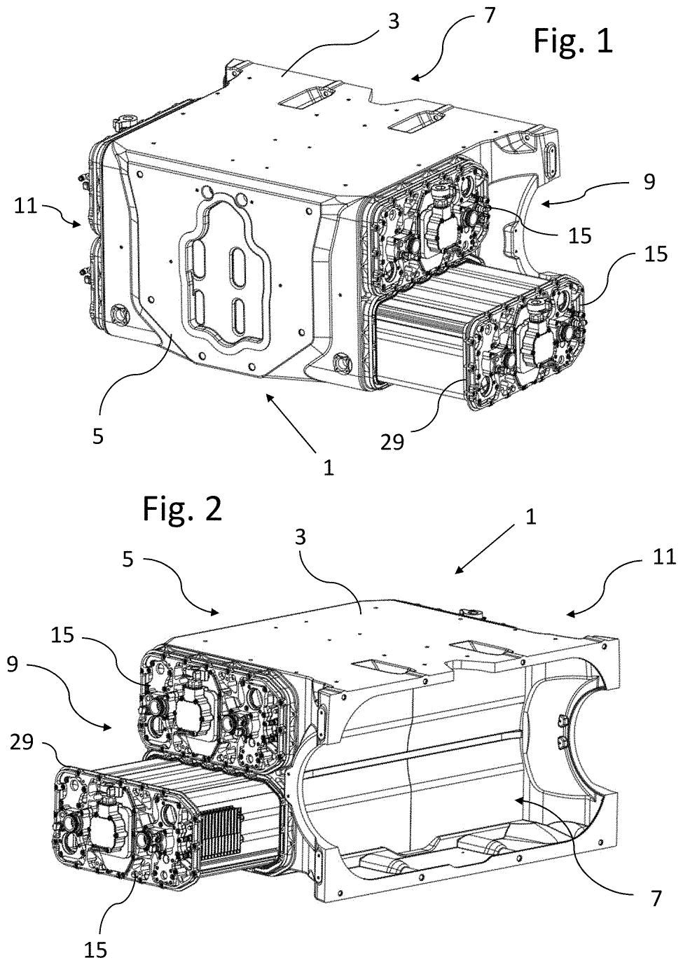

The accompanying figures show different parts of a fuel-cell battery pack which is in accordance with an exemplified embodiment of the invention. As shown in particular in the perspective views of FIGS. 1 and 2, the fuel-cell battery pack comprises a casing (reference sign 1) which has the general shape of a parallelepiped with a top side 3, a bottom side (not shown), a front side 7, a rear side 5 and two lateral sides, one right 9 and one left 11. The casing 1 is preferably produced from a composite material such as fibreglass or carbon fibre. The illustrated fuel-cell battery pack is designed to power an electric propulsion automobile. For this purpose, it comprises four fuel-cell stacks. Still referring to the same figures, it can also be seen that the casing 1 comprises two pairs of superposed openings which are arranged symmetrically, one of the pairs opening on the left lateral side and the other on the right lateral side. It can likewise be seen that each fuel-cell stack is inserted into one of the four openings.

The electric propulsion vehicle which is provided with the fuel-cell battery pack 1 of the present example is intended to be used in motor racing. In the present example, the main components of the racing car (the fuel-cell battery pack, but also the components which are not shown, such as the vehicle front end, the cockpit and the vehicle back end with its two electric motors) are directly assembled together so as to form a self-supporting structure having sufficient rigidity to meet the function of a chassis for the vehicle. The casing 1 is thus provided to be mounted on the cockpit via its front side 7 and on the vehicle back end via its rear side 5. Referring more particularly to FIG. 1B, it can be seen that the front side 7 of the casing 1 also comprises a cavity provided to contain a hydrogen tank mounted horizontally and transversely between the fuel-cell battery pack and the cockpit (not shown). It will also be understood that the two lateral sides 9 and 11 are referred to as “right” and “left” because they are intended to be located on the right and left side respectively of the automobile provided with the fuel-cell battery pack.

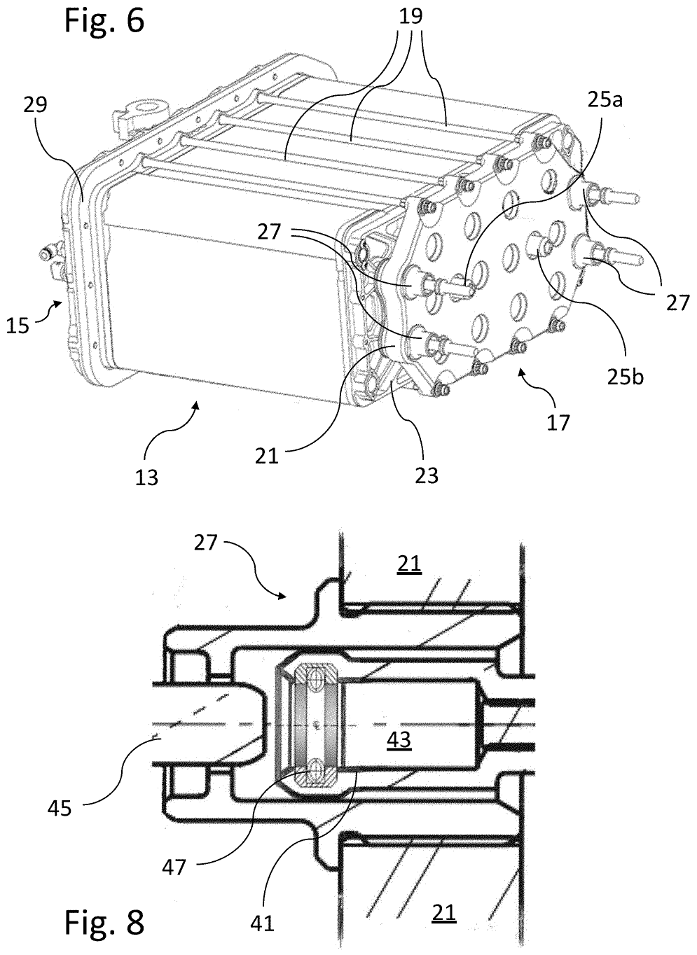

The perspective view of FIG. 6 shows a single one of the four fuel-cell stacks without the other components of the fuel-cell battery pack. Referring to this figure, it can be seen that the fuel-cell stack (reference sign 13) comprises two end plates (reference signs 15 and 17) and a stack of planar fuel cells compressed between the two end plates (so as not to complicate the drawing, the individual fuel cells are not shown. However, the outer contour of the stack of cells can be seen in the figure, between the two end plates 15, 17). The fuel-cell stack 13 also comprises a linking structure, the function of which is to generate a compression force allowing the stack of fuel cells to be compressed between the two end plates 15, 17. In the present example, the linking structure comprises eight tie rods (reference sign 19) which are arranged in parallel with the stacking direction and are bolted by their ends to the two end plates. In a manner known per se, the presence of such a linking structure allows, on the one hand, the sealing tightness of the fuel-cell stack to be ensured and allows, on the other hand, uniform distribution of the electrical conduction in the fuel cells. In a manner known per se, the fuel cells which are compressed between the end plates of a fuel-cell stack are electrically connected in series, such that the fuel-cell stack comprises a positive pole and a negative pole which are located at opposite ends of the stack. Each end of the stack further comprises a current collector which is associated with the end plate arranged at the same end. Each current collector is further electrically connected to an electrical connection terminal provided on this end plate.

The two end plates 15, 17 of the fuel-cell stack of the present example are not identical. Still referring to FIG. 6, it can be seen in particular that the end plate with the reference sign 17 is not in one piece. On the contrary, it is formed by a set of separate elements which are connected together. These elements are mainly a bearing structure (or plate) (reference sign 21), a closure plate (reference sign 23) and a current collector (not shown). As can be seen, the tie rods 19 of the linking structure are bolted to the bearing structure 21, whereas the closure plate 23 and the current collector are sandwiched between the bearing structure 21 and the end of the stack of fuel cells. The bearing structure 21 and the closure plate 23 are furthermore kept spaced apart from each other by a plurality of compression springs (not shown). In the illustrated example, the bearing structure 21 is in the form of a plate perforated with several rows of circular openings. It will be understood that the circular openings in particular provide access to the closure plate 23. At the opposite end of the fuel-cell stack 13, the other end plate (reference sign 15) has a peripheral rim 29. This peripheral rim is furthermore the only part of the end plate 15 which can be seen in FIG. 6. In contrast, FIGS. 1 and 2 show the outer side of the end plate 15 of each of the four fuel-cell stacks. Referring again to these two figures, it can be seen in particular that the peripheral rim 29 is sized so as to allow it to come into abutment against the periphery of the opening in the casing 1 into which the fuel-cell stack 13 is inserted. It will be understood that, owing to the presence of the peripheral rim, the surface of the end plate 15 is larger than that of the end plate 17. This is the reason why the end plates 15 and 17 will be referred to hereinafter as the large end plate and the small end plate respectively.

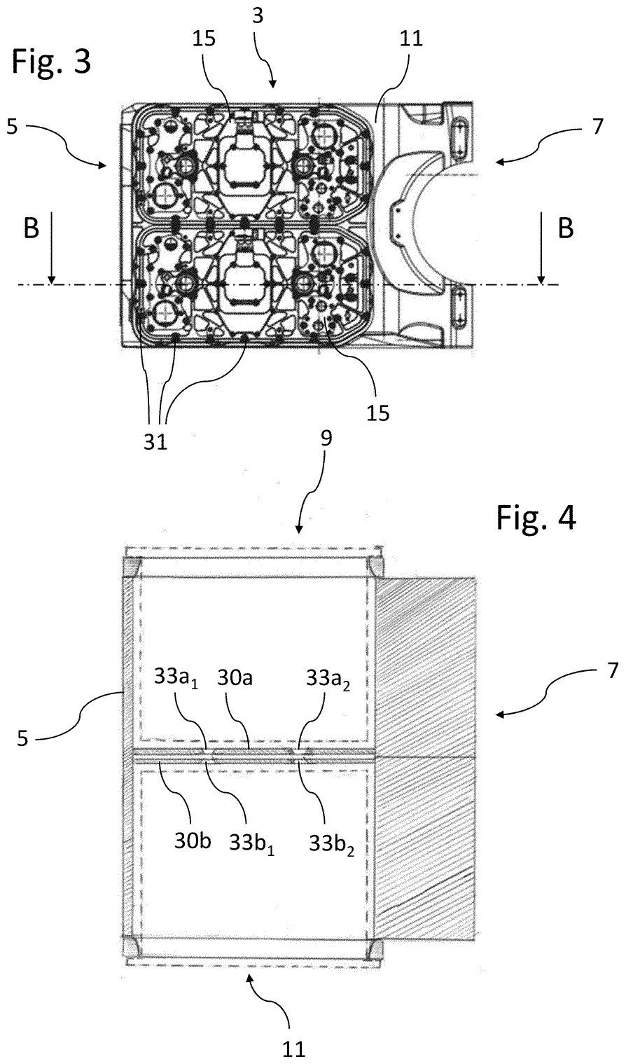

Referring still to FIGS. 1 and 2, it can be seen that the outer side of the end plate 15 bears a plurality of connectors for conduits. These conduits correspond respectively to the inlets and outlets for the reactive anode gas, the reactive cathode gas and the cooling fluid of the fuel-cell stack. In the illustrated example, these inlets and these outlets are all grouped together on the large end plate 15 such that all of these connectors are accessible from outside of the casing 1. In accordance with an advantageous embodiment, the peripheral rim of the large end plate 15 is fixed to the casing 1 at at least two points, such that the large end plate contributes to the rigidity of the fuel-cell battery pack. Referring now to the side view of FIG. 3, it can be seen that in the illustrated example the large end plate 15 is fixed to the casing 1 using sixteen screws (reference sign 31). It will be understood that the large end plate is provided to this end with piercings which are distributed more or less evenly around the peripheral rim 29 and that the sixteen screws are screwed into the casing 1 through the piercings in the peripheral rim.

FIG. 4 is a cross-sectional view of the fuel-cell battery pack at B-B of FIG. 3. It will be understood that the fuel-cell stacks accommodated in the casing 1 of the fuel-cell battery pack are not shown in FIG. 4, so as not to complicate the drawing. However, the position which would be taken up by the fuel-cell stacks if they were in the casing is indicated by a broken line. FIG. 4 shows in particular that each housing has a back wall (reference signs 30a and 30b respectively) arranged opposite the opening. In the illustrated example, the back walls 30a, 30b are in parallel with the right and left sides of the casing 1. In accordance with the embodiment to which the present example relates, each of the four housings of the casing 1 further comprises a guide arranged to cooperate with the small end plate of one of the fuel-cell stacks to guide it when the fuel-cell stack is being placed, as well as to maintain the position of the small end plate when the fuel-cell stack is in place in its housing. It will be understood that the four fuel-cell stacks can be placed in the casing, or alternatively be removed therefrom, somewhat like four drawers. Referring now more particularly to FIGS. 4 and 6, it can be seen that in the illustrated example the end plate 17 of the fuel-cell stack 13 has two pins (reference signs 25a and 25b) which are oriented in the stacking direction. It can be seen that these pins are fixed to the closure plate 23 and that they each pass through one of the circular openings of the bearing structure 21 so as to protrude therefrom. It can also be seen that the walls 30a, 30b, at the back of the housings, each have two cavities (reference signs 33a₁, 33a₂ and 33b₁, 33b₂ respectively) which are arranged facing the opening of the housing. It will be understood that the two pins 25a, 25b borne by the end plate of each of the fuel-cell stacks are arranged to come to be inserted progressively into the two cavities 33a₁ and 33a₂ or 33b₁ and 33b₂, when the fuel-cell stack is inserted into a housing. The cooperation of the pins 25a, 25b with the cavities 33a₁ and 33a₂ or 33b₁ and 33b₂ allows the fuel-cell stack to be guided as it is being placed in the housing and also to be kept in position once the fuel-cell stack is in place.

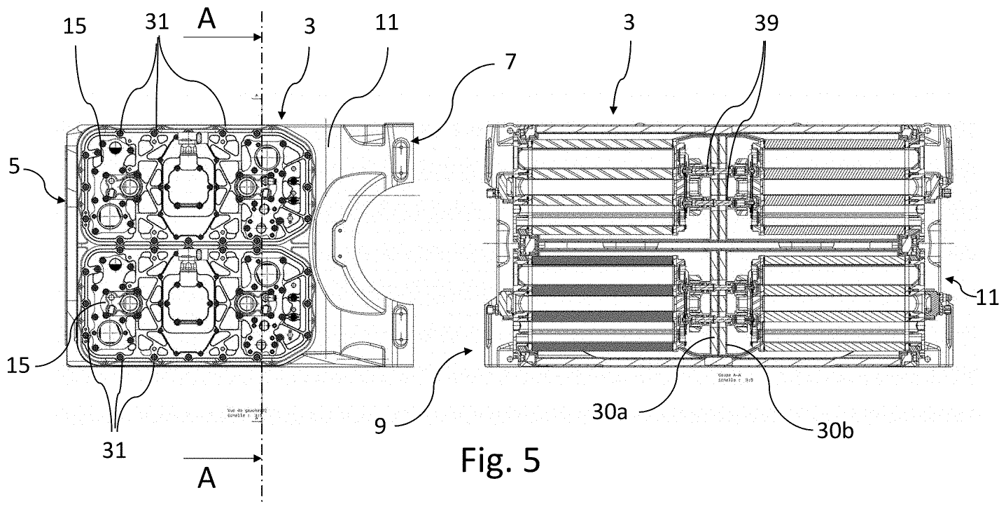

FIGS. 5, 6, 7 and 8 show in particular connection means allowing the electrical connection of at least one connection terminal of the small end plate 17 of each of the fuel-cell stacks to an electrical conductor which is arranged at the back of the housing of the fuel-cell stack, facing the small end plate. Referring firstly to FIG. 6, it can be seen that the bearing structure 21 of the end plate 17 bears four female electrical connectors (each with reference sign 27). FIG. 8 is a partial enlarged view of one of these female electrical connectors. In the present example, these connectors are of the BAL SEAL® type. They each comprise a body (or socket) 41 having a bore 43 arranged to receive an electric plug 45. The wall of the bore has a concentric, circular groove in which a helical spring 47 is accommodated. The diameter of the coils of the helical spring is sufficient for the spring to protrude from the groove such that, when the plug 45 is introduced into the female connector, the spring 47 is compressed between the electric plug and the base of the groove. The female connector 27 is furthermore connected to the current collector (not shown) of the end plate 17 by means which are not shown. In connectors of this type, the helical spring fulfils two functions. On the one hand, it electrically connects the plug 45 to the female connector 27. On the other hand, it allows the plug 45 to be retained in the socket 41 in a slip fit.

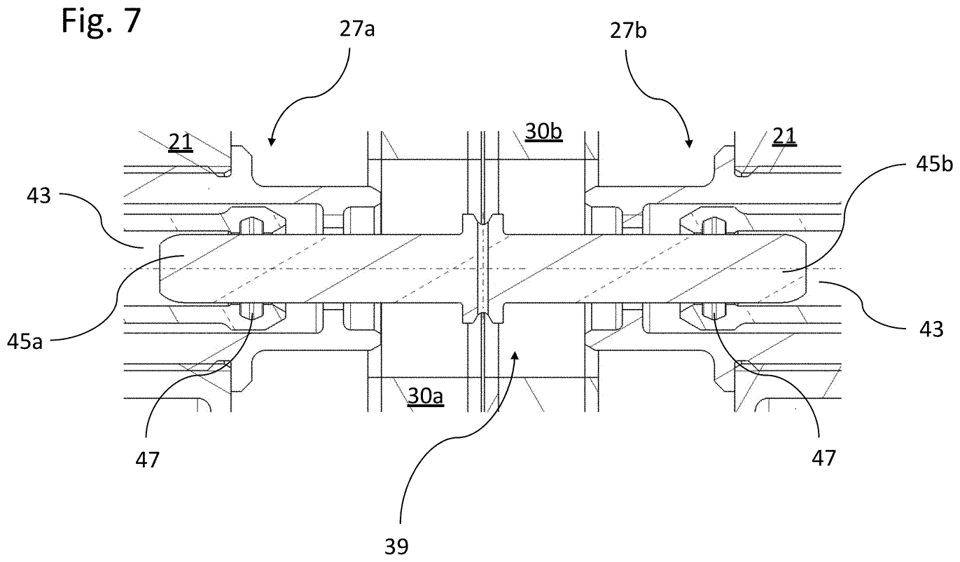

FIG. 7 is a partial enlarged view schematically showing connecting means provided to connect the small end plates of two fuel-cell stacks contained in two housings arranged symmetrically in the casing and separated from each other by a central wall which forms the back of each of the housings. The illustrated connection means allow the electrical connection of the small end plates of two fuel-cell stacks through the wall separating their respective housings. In accordance with the invention, the connection means illustrated in FIG. 7 are just as suitable for electrically connecting two fuel-cell stacks in parallel as for connecting them in series. However, in accordance with the embodiment to which the present example relates the two fuel-cell stacks are connected in series via their small end plate. This is why the stacks are not identical. In fact, for such a connection, it is necessarily the case that one of the two fuel-cell stacks has its positive pole on the side of its small end plate whilst the other fuel-cell stack has its small end plate on the side of its negative pole.

FIG. 7 shows two female connectors 27a and 27b which are respectively mounted on the small end plates of two fuel-cell stacks (not shown). It can be seen that the two female connectors are arranged facing each other on either side of the wall 30a, 30b which forms the back of the housings of the two fuel-cell stacks. The female connectors are provided to cooperate with the two ends of a bridging bar 39 which is mounted in an opening in the wall 30a, 30b. As shown in FIG. 7, the bridging bar 39 is essentially formed from a pair of male plugs 45a, 45b arranged coaxially back-to-back. The bridging bar 39 is mounted in a floating manner in an opening passing through the wall, such that the two plugs 45a and 45b respectively protrude from the two sides of the wall 30a, 30b.

Still referring to FIG. 7, it will be understood that, when the two fuel-cell stacks (not shown) are brought into position in their respective compartments, and that being done, the distance separating the female connectors 27a and 27b of the two fuel-cell stacks decreases until becoming smaller than the length of the bridging bar 39, the two ends of the bridging bar will naturally come to be inserted into the bores of the two female connectors 27a and 27b. As it is the helical spring of each of the female connectors which ensures the electrical contact between the connectors and the bridging bar, the ends of the bridging bar can slide in the bores of the female connectors in order to absorb any possible longitudinal clearance which may appear between the wall 30a, 30b and each of the female connectors.

It will also be understood that various modifications and/or improvements obvious to a person skilled in the art can be made to the embodiments being described in the present description without departing from the scope of the present invention defined by the accompanying claims.

1. A fuel-cell battery pack for an electric propulsion vehicle, comprising:
at least one fuel-cell stack comprising two end plates, a stack of fuel cells which is compressed between the two end plates, and a linking structure fixedly anchored to the two end plates and pre-tensioned so as to pull the end plates together in order to compress the stack of fuel cells, and further comprising inlets and outlets for a reactive anode gas, a reactive cathode gas and a cooling fluid;
a casing comprising a housing therein for said at least one fuel-cell stack, and comprising at least one opening providing access to said housing, the housing comprising a back wall arranged opposite the opening;
wherein said at least one fuel-cell stack is inserted in the opening by one end of said at least one fuel-cell stack such that one of the two end plates (referred to hereinafter as the small end plate) is located within the housing whilst the other end of the fuel-cell stack protrudes out of the opening, the other end plate (referred to hereinafter as the large end plate) being located outside of the casing, and having a peripheral rim provided to be kept in abutment against the periphery of the opening; and
wherein the inlets and outlets for the reactive anode gas, the reactive cathode gas and the cooling fluid are arranged on the large end plate.

2. The fuel-cell battery pack according to claim 1, wherein the peripheral rim of the large end plate is fixed to the casing at at least two points, such that the large end plate contributes to the rigidity of the fuel-cell battery pack.

3. The fuel-cell battery pack according to claim 1, wherein the casing comprises a guide arranged in the housing so as to cooperate with the small end plate to guide the small end plate when the fuel-cell stack is being placed in the housing, as well as to keep the small end plate in position when the fuel-cell stack is in place.

4. The fuel-cell battery pack according to claim 3, wherein the guide comprises a cavity provided in the back wall of the housing opposite the opening and wherein the small end plate of the fuel-cell stack comprises a pin oriented in the stacking direction of the fuel cells, the pin being arranged to come to be inserted into the cavity when the fuel-cell stack is inserted into the casing.

5. The fuel-cell battery pack according to claim 1, wherein the small end plate of the fuel-cell stack comprises a current collector and a first electrical connector fixedly attached to the current collector, the first electrical connector facing the back of the housing, and wherein the back of the housing comprises a second electrical connector arranged to cooperate with the first electrical connector.

6. The fuel-cell battery pack according to claim 5, further comprising a pair of fuel-cell stacks, wherein the casing comprises a left lateral side and a right lateral side which are parallel and substantially mutually symmetrical with respect to a vertical plane of symmetry, and further comprises two openings in which the two fuel-cell stacks of the pair are respectively inserted, the two openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the bases of the housings to which the pair of openings respectively provide access.

7. The fuel-cell battery pack according to claim 6, wherein the current collector of the small end plate of one of the two fuel-cell stacks of the pair of fuel-cell stacks forms the current collector's positive pole whilst the positive pole of the other fuel-cell stack is formed by the current collector of its large end plate, wherein the small end plate of each of the two fuel-cell stacks has an electrical connector which is attached to the small end plate's current collector and which faces the back of the housing in which the small end plate is located, and wherein said back wall has two other electrical connectors which are each arranged to cooperate with the electrical connector of the small end plate of one of the two fuel-cell stacks, said two other connectors being furthermore connected to each other through the wall such that the two fuel-cell stacks are connected in series when the two fuel-cell stacks of the pair are in place in the two fuel-cell stack's respective housings.

8. The fuel-cell battery pack according to claim 5, further comprising two pairs of fuel-cell stacks, wherein the casing comprises a left lateral side and a right lateral side which are parallel and substantially mutually symmetrical with respect to a vertical plane of symmetry, and further comprises two pairs of openings, the two fuel-cell stacks of a first one of the two pairs of fuel-cell stacks being respectively inserted into the two openings of one of the two pairs of openings and the two fuel-cell stacks of the second pair of fuel-cell stacks being respectively inserted into the two openings of the other pair of openings, the two openings of each pair of openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the backs of the housings to which the two pairs of openings provide access.

9. The fuel-cell battery pack according to claim 8, wherein the current collector of the small end plate of one of the two fuel-cell stacks of each pair of fuel-cell stacks forms the positive pole of this fuel-cell stack whilst the positive pole of the other fuel-cell stack of the same pair of fuel-cell stacks is formed by the current collector of its large end plate, wherein the small end plate of each fuel-cell stack has an electrical connector which is attached to its current collector and which faces the base of the housing in which the small end plate is located, and wherein said back wall has four other electrical connectors which are each arranged to cooperate with the electrical connector of the small end plate of one of the fuel-cell stacks, said four other connectors being furthermore connected two-by-two through the back wall such that the two fuel-cell stacks of each of the pairs of fuel-cell stacks are connected in series when the two fuel-cell stacks of each of the pairs of fuel-cell stacks are in place in the two fuel-cell stack's respective housings.

10. The fuel-cell battery pack according to claim 2, wherein the casing comprises a guide arranged in the housing so as to cooperate with the small end plate to guide the small end plate when the fuel-cell stack is being placed in the housing, as well as to keep the small end plate in position when the fuel-cell stack is in place.

11. The fuel-cell battery pack according to claim 2, wherein the small end plate of the fuel-cell stack comprises a current collector and a first electrical connector fixedly attached to the current collector, the first electrical connector facing the back of the housing, and wherein the back of the housing comprises a second electrical connector arranged to cooperate with the first electrical connector.

12. The fuel-cell battery pack according to claim 3, wherein the small end plate of the fuel-cell stack comprises a current collector and a first electrical connector fixedly attached to the current collector, the first electrical connector facing the back of the housing, and wherein the back of the housing comprises a second electrical connector arranged to cooperate with the first electrical connector.

13. The fuel-cell battery pack according to claim 4, wherein the small end plate of the fuel-cell stack comprises a current collector and a first electrical connector fixedly attached to the current collector, the first electrical connector facing the back of the housing, and wherein the back of the housing comprises a second electrical connector arranged to cooperate with the first electrical connector.

14. The fuel-cell battery pack according to claim 1, further comprising a pair of fuel-cell stacks, wherein the casing comprises a left lateral side and a right lateral side which are parallel and substantially mutually symmetrical with respect to a vertical plane of symmetry, and further comprises two openings in which the two fuel-cell stacks of the pair are respectively inserted, the two openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the bases of the housings to which the pair of openings respectively provide access.

15. The fuel-cell battery pack according to claim 2, further comprising a pair of fuel-cell stacks, wherein the casing comprises a left lateral side and a right lateral side which are parallel and substantially mutually symmetrical with respect to a vertical plane of symmetry, and further comprises two openings in which the two fuel-cell stacks of the pair are respectively inserted, the two openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the bases of the housings to which the pair of openings respectively provide access.

16. The fuel-cell battery pack according to claim 3, further comprising a pair of fuel-cell stacks, wherein the casing comprises a left lateral side and a right lateral side which are parallel and substantially mutually symmetrical with respect to a vertical plane of symmetry, and further comprises two openings in which the two fuel-cell stacks of the pair are respectively inserted, the two openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the bases of the housings to which the pair of openings respectively provide access.

17. The fuel-cell battery pack according to claim 4, further comprising a pair of fuel-cell stacks, wherein the casing comprises a left lateral side and a right lateral side which are parallel and substantially mutually symmetrical with respect to a vertical plane of symmetry, and further comprises two openings in which the two fuel-cell stacks of the pair are respectively inserted, the two openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the bases of the housings to which the pair of openings respectively provide access.

18. The fuel-cell battery pack according to claim 2, further comprising two pairs of fuel-cell stacks, wherein the casing comprises a left lateral side and a right lateral side which are parallel and substantially mutually symmetrical with respect to a vertical plane of symmetry, and further comprises two pairs of openings, the two fuel-cell stacks of a first one of the two pairs of fuel-cell stacks being respectively inserted into the two openings of one of the two pairs of openings and the two fuel-cell stacks of the second pair of fuel-cell stacks being respectively inserted into the two openings of the other pair of openings, the two openings of each pair of openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the backs of the housings to which the two pairs of openings provide access.

19. The fuel-cell battery pack according to claim 3, further comprising two pairs of fuel-cell stacks, wherein the casing comprises a left lateral side and a right lateral side which are parallel and substantially mutually symmetrical with respect to a vertical plane of symmetry, and further comprises two pairs of openings, the two fuel-cell stacks of a first one of the two pairs of fuel-cell stacks being respectively inserted into the two openings of one of the two pairs of openings and the two fuel-cell stacks of the second pair of fuel-cell stacks being respectively inserted into the two openings of the other pair of openings, the two openings of each pair of openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the backs of the housings to which the two pairs of openings provide access.

20. The fuel-cell battery pack according to claim 4, further comprising two pairs of fuel-cell stacks, wherein the casing comprises a left lateral side and a right lateral side which are parallel and substantially mutually symmetrical with respect to a vertical plane of symmetry, and further comprises two pairs of openings, the two fuel-cell stacks of a first one of the two pairs of fuel-cell stacks being respectively inserted into the two openings of one of the two pairs of openings and the two fuel-cell stacks of the second pair of fuel-cell stacks being respectively inserted into the two openings of the other pair of openings, the two openings of each pair of openings being arranged symmetrically, one on the left lateral side and the other on the right lateral side, and wherein said back wall takes up a position merging with the vertical plane of symmetry between the left lateral side and the right lateral side of the casing, the back wall comprising a left face and a right face which form the backs of the housings to which the two pairs of openings provide access.
